(19) United States
(12) Patent Application Publication
(10) Pub. No.: US 2008/0060885 A1
(43) Pub. Date: Mar. 13, 2008

(54) BRAKE SYSTEM WITH HYDRAULIC BRAKE EQUIPMENT

(75) Inventors: Stefan Ruckh, Romerstein/Zainingen (DE); Jurgen Beier, Ulm (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: GUSTAV MAGENWIRTH GMBH & CO. KG, Bad Urach (DE)

(21) Appl. No.: 11/846,548

(22) Filed: Aug. 29, 2007

(30) Foreign Application Priority Data
Aug. 29, 2006 (DE) 10 2006 040 328.2

(51) Int. Cl. B62L 3/02

(52) U.S. Cl. 188/26

(57) ABSTRACT

A hydraulic brake system for two-wheel vehicles, especially bicycles, is provided. The system has a filling device, and a dispensing system filled with hydraulic fluid and a brake mechanism hydraulically connected to the dispensing system. The dispensing system also has an equalizing reservoir and a filling and bleeding opening. A bleeding and filling tool with a piston/cylinder arrangement is also provided that is used with the brake system. At least the filling and bleeding opening of the dispensing system is detachably coupleable with the bleeding and filling tool. The bleeding and filling tool is preferably a standard syringe.

### FIELD OF THE INVENTION

The invention relates to a brake system with hydraulic brake equipment for two-wheel vehicles, especially bicycles.

### BACKGROUND

The invention relates to a brake system with hydraulic brake equipment for two-wheel vehicles, especially bicycles, with a filling device for the brake equipment, wherein the brake equipment has a dispensing system filled with hydraulic fluid and a brake mechanism connected to this dispensing system hydraulically, with the dispensing system having an equalizing reservoir and a filling and bleeding opening. For mounting or maintenance work on hydraulic brake equipment, the emptying, filling, and bleeding of the hydraulic system is also necessary.

For this purpose, the hydraulic system can have a closable opening in the region of the brake mechanism located on the wheel, especially on the brake caliper, and also a filling and bleeding opening of the equalizing reservoir on the dispensing system. The brake fluid is filled through the opening on the brake caliper (brake caliper valve) under pressure until brake fluid without bubbles escapes from the top in the equalizing reservoir when the equalizing reservoir cover has been removed or from the filling and bleeding opening.

Because the greatest caution is necessary when handling brake fluid due to its aggressivity, it must be ensured that during the filling and bleeding, no brake fluid leaks out and causes damage to vehicle components or make them unusable. Skin contact should also be reliably prevented. For the reasons named above, comparatively large equipment, which is difficult to handle and that can present problems to an inexperienced user, is used when handling brake fluid during filling and bleeding.

The brake fluid to be filled is typically decanted from closed air-tight containers into a plastic bottle, which is then connected to the brake caliper valve via a hose. A collection container for collecting discharged brake fluid is connected via a hose to the filling and bleeding opening of the dispensing system.

By squeezing the plastic bottle, the brake fluid is forced through the hydraulic system until it escapes without bubbles from the top in the equalizing reservoir or from the filling and bleeding opening. Here, the plastic bottle must be squeezed together and restored to its original form several times until no air bubbles emerge from the brake caliper.

Overall, the filling and bleeding of the hydraulic system is complicated in terms of handling, especially for those not skilled in the art, and also in terms of the necessary equipment, wherein sometimes makeshift arrangements are used as aids for holding the containers that are used. In addition, there is an elevated risk that hydraulic fluid will spill during the handling and that in this way damage and/or injury could result.

### SUMMARY

The object of the present invention is to simplify and make safer the filling and bleeding of the hydraulic system in a brake system of the type named above, so that the brake system can be easily filled and bled dribble-free and without contaminating the surroundings with brake fluid.

To this end, it is proposed that a bleeding and filling tool with a piston/cylinder arrangement is allocated to the brake equipment and that at least the filling and bleeding opening of the dispensing system is constructed for detachable coupling with this bleeding and filling tool.

With such a tool having a piston/cylinder arrangement, an especially good capability for dosing the hydraulic fluid to be filled is provided. This is especially important in consideration of the low filling amount, for example, for hydraulic brake equipment for bicycles. In addition, both pressure and also a relatively high vacuum can be generated, through which, in addition to a flushing filling of the hydraulic system, also a suction filling of the hydraulic system is possible. Thus, the bleeding and filling tool can be connected tightly at the top to the filling and bleeding opening of the dispensing system and then through suctioning with its piston/cylinder arrangement, hydraulic fluid is suctioned from the bottom end of the hydraulic system until bubble-free hydraulic fluid is emitted from the top.

Preferably, the detachable connection between the bleeding and filling tool and the filling and bleeding opening of the dispensing system is formed through a sealing insertion process.

Through the sealing insertion of the bleeding and filing tool, filling and/or bleeding of the hydraulic system can be performed essentially without additional aids.

The filling and bleeding opening of the dispensing system is preferably arranged on the top side of this system and especially in a cover of the equalizing reservoir.

The filling and bleeding opening is thus located on the top side of the dispensing system, which produces a favorable position for the filling and bleeding.

The orientation direction of the filling and bleeding opening is aligned, in particular, essentially vertically or somewhat diagonally, so that the bleeding and filling tool can be inserted from above.

Preferably, the bleeding and filling tool has a connecting sleeve or a similar connecting element for sealing insertion into the filling and bleeding opening(s).

The bleeding and filling tool can be inserted with its connecting sleeve directly into the filling and bleeding opening and is then held in an approximately vertical or somewhat diagonal position. Additional holding aids are not necessary.

In particular, through a conical connection between a connecting sleeve and the filling and bleeding opening, a tight and secure connection, which is pressure-tight and vacuum-tight and which contributes to simple and clean handling during filling and bleeding processes, is provided just through an insertion process.

It is especially preferable when the connecting sleeve of the bleeding and filling tool has a Luer cone or a Luer lock and when the filling and bleeding opening of the equalizing reservoir fits the connecting sleeve. Both the Luer cone for insertion and also the Luer lock for screwing-in form proven, easy to handle, tight, and safe connections.

If a Luer cone or Luer lock is used as a conical connection, in an especially advantageous way, a standard syringe, which is available practically anywhere and which is economical and whose common fill volume of, for example, 10 ml or 20 ml, is sufficient for a complete filling and/or bleeding of a hydraulic system, especially for bicycles, could be used as the bleeding and filling tool without having to be attached and removed several times.

Preferably, the brake mechanism also has a filling and bleeding opening, which is constructed for detachable coupling with the bleeding and filling tool through a preferably sealing insertion process. Here, the filling and bleeding opening of the brake mechanism also fits the connecting sleeve of the bleeding and filling tool formed especially by a syringe.

For a filling and bleeding process, in the brake mechanism, a syringe filled with hydraulic fluid or some other container with hydraulic fluid can be connected, while an empty syringe for suctioning is tightly docked to the filling and bleeding opening. By drawing on the upper, empty syringe, the hydraulic fluid is suctioned through the hydraulic system, wherein quick filling and bleeding is possible, if necessary supported through simultaneous pressing on the bottom, filled syringe.

The bleeding and filling tool can also be integrated into the dispensing system, that is, be part of the dispensing system. Here, it can be attached permanently to the equalizing reservoir or else held in a holder and for the filling and bleeding process, it can be detached or removed and coupled tightly with the filling and bleeding opening.

According to one embodiment of the invention, at least the filling and bleeding opening of the dispensing system can have an insertion section in an equalizing reservoir cover for tight holding of the connecting sleeve of the bleeding and filling tool, wherein a preferably cup-shaped connection chamber in the dispenser housing connects to the insertion section in the insertion direction. A part of the connecting sleeve projects into this connection chamber, which has at least one connection for the equalizing reservoir.

The filling and bleeding opening is arranged on the top side of the dispensing system and thus at a favorable position for the filling and bleeding. The insertion section in the cover and the cup-shaped connection chamber in the dispenser housing are flush with each other and are oriented preferably in the ejection direction of a mold for producing these parts, so that simple production is possible.

In the insertion section in the cover, the bleeding and filling tool or its connecting sleeve is held securely after insertion and in a simple way a flow connection to the equalizing reservoir is provided via the connection chamber and the overflow opening.

Through the secure holding of the bleeding and filling tool, for emptying, filling, and bleeding the hydraulic system, it is achieved that no brake fluid or hydraulic fluid leaks out and causes damage to vehicle components or makes these unusable. Also, skin contact with hydraulic fluid is reliably prevented. From the reasons named above, up until now relatively large, difficult to handle equipment, which could present problems to an inexperienced user, has to be used when handling brake fluid during the filling and bleeding.

The connection chamber is preferably a side boundary wall to the equalizing reservoir. At least one overflow opening that is open at the top edge in this boundary wall is provided as a connection to the equalizing reservoir.

This overflow opening, which is open at the edge and which is oriented in the same way as the insertion section and the connection chamber in the ejection direction of a mold, also contributes to a simple construction of the mold and to a simplified production.

An advantageous construction provides that the connection chamber has open internal dimensions, which are greater than the projecting part of the connecting sleeve, and that the overflow opening, which is open at the edge, in the boundary wall of the connection chamber is arranged in a region at a distance from the highest position of the side boundary wall in the operating position of the dispensing system.

Through this dimensioning of the connection chamber, there is sufficient space for circulation of the fluid (hydraulic fluid, air) around the connecting sleeve, so that the fluid can be led via the overflow opening to the connection chamber and vice versa.

Through the special position of the overflow opening that is open at the edge, the connection chamber forms an air trap for air bubbles in the hydraulic fluid. These bubbles remain trapped in the connection chamber due to the lower arrangement of the overflow opening in relation to the highest position of the internal space or its boundary wall in the connection chamber and cannot be led into the equalizing reservoir and into the further hydraulic circuit.

According to one embodiment, two overflow openings, which are open at the edge and which are arranged preferably approximately opposite each other, are provided in the boundary wall. These are then positioned offset by approximately 90° or more relative to the highest position of the internal space of the connection chamber.

According to an advantageous improvement of the invention, the overflow opening (or also several overflow openings) arranged in the boundary wall of the connection chamber are formed as a narrow edge slot, wherein the slot width is dimensioned for keeping back air bubbles contained in the hydraulic fluid.

Here, air bubbles, in particular, which rise in the hydraulic fluid due to the force of gravity, are kept back.

According to an embodiment of the invention, the overflow opening from the connection chamber to the equalizing reservoir can be arranged in a counterpart contacting the boundary wall instead of in the boundary wall of the connection chamber. The counterpart contacting the boundary wall can be, in particular, the cover or a seal between the cover and the equalizing reservoir.

This is provided primarily when the introduction of one or more overflow openings into the connection chamber boundary wall is problematic.

This can be the case, for example, for a dispenser housing made from metal, especially from forged metal, because relatively filigree spheroidization and moldings can be realized here only with difficulty and, in particular, not without complicated finishing work.

In such a case, the overflow openings(s) from the connection chamber to the equalizing reservoir can be provided in the cover itself or in a seal between the cover and the equalizing reservoir.

Here, the overflow opening(s) can be constructed in their region overlapping the boundary wall with a channel shape as a groove that is open at the edge and that faces and overlaps the boundary wall with its opening.

Preferably, it is provided that the seal with the one or more overflow openings is the surrounding side flange of the elastic bellows.

### BRIEF DESCRIPTION OF THE DRAWINGS

Additional constructions of the invention are listed in the other subordinate claims. Below, the invention is described in more detail in one embodiment with reference to the drawings, in which:

FIG. 1 is a view of hydraulic brake equipment with a dispensing system and a brake mechanism arranged on a brake disk,

FIG. 2 is a section view of the dispensing system shown in FIG. 1,

FIG. 3 is a section view of the brake mechanism shown in FIG. 1,

FIG. 4 is a section view of a dispensing system in a filling and bleeding position with attached bleeding and filling tool,

FIG. 5 is a section view of the dispensing system in the operating position,

FIG. 6 is an enlarged view of the dispensing system from FIG. 4 in the filling and bleeding position,

FIG. 7 is an enlarged section view of the dispensing system from FIG. 5 in the operating position,

FIG. 8 is a top view of a dispensing system with open equalizing reservoir,

FIG. 9 is a top view of a dispensing system with attached bleeding and filling tool,

FIG. 10 is a top view of an equalizing reservoir cover,

FIG. 11 is a side view of the cover shown in FIG. 10,

FIG. 12 is an enlarged view of a cover region with a filling and bleeding opening,

FIG. 13 is a perspective view of a bellows,

FIG. 14 is a section view of the dispensing system with overflow openings in the surrounding side flange of an elastic bellows,

FIG. 15 is a narrow side view of a bellows with overflow openings, and

FIG. 16 is a bottom side view of the bellows shown in FIG. 15.

### DETAILED DESCRIPTION OF THE PREFERRED EMBODIMENTS

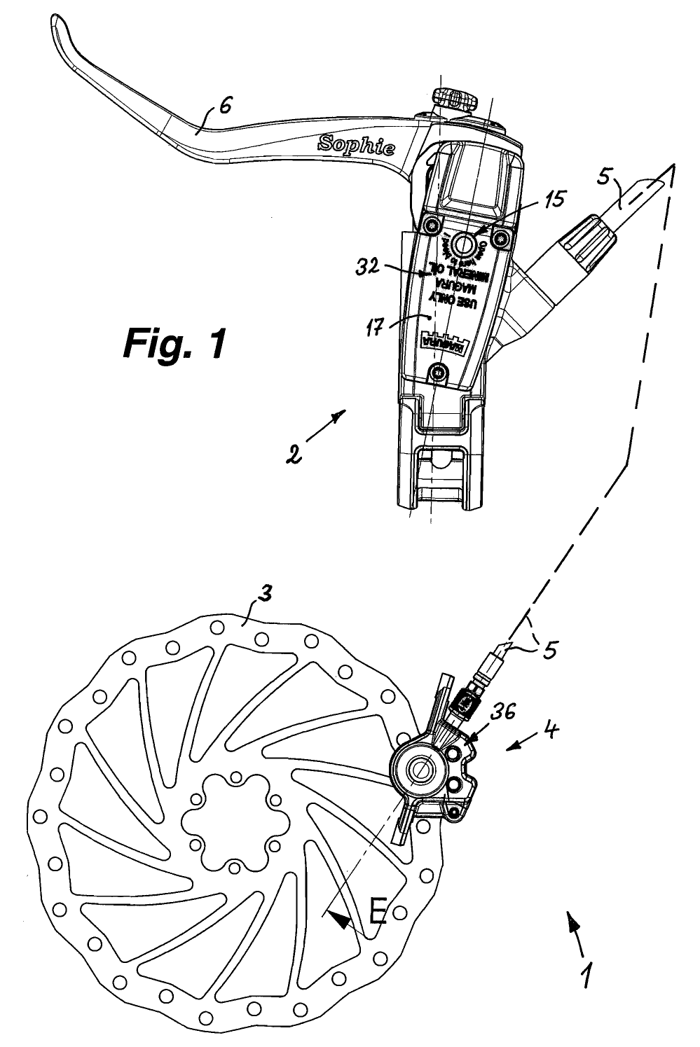

A hydraulic brake system 1 shown in FIG. 1 can be used especially for bicycles but also for other two-wheel vehicles. It has a dispensing system 2 and also a brake mechanism 4 attached to a brake disk 3. The brake system is filled with hydraulic fluid, with the dispensing system 2 being connected to the brake mechanism 4 via a hydraulic line 5 indicated with dashed lines.

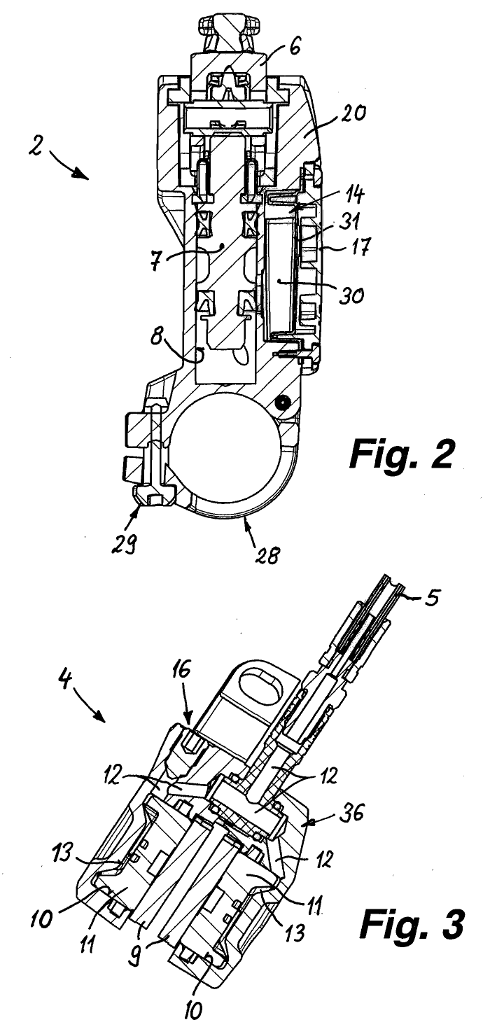

The dispensing system 2 has a hand-activated brake lever 6, with which a dispenser piston 7 (cf. FIG. 2) guided in a cylinder 8 can be moved and in this way, hydraulic fluid is led to the brake mechanism 4 via the hydraulic line 5. This brake mechanism 4 has brake calipers 36 arranged on the brake disk 3 connected to the wheel to be braked. Force is applied to the brake disk 3 on both sides with two brake pads 9 during braking (FIG. 3). For this purpose, brake pistons 11, which are guided in brake cylinders 10 and which receive force on the back side from hydraulic fluid, are provided. The hydraulic fluid is guided from the hydraulic line 5 via channels 12 to pressure chambers 13 located behind the brake piston 11.

The dispensing system 2 has an equalizing reservoir 14 for hydraulic fluid, which is connected to the cylinder 8 and thus to the hydraulic circuit when the brake lever 6 is not activated.

To be able to fill and bleed the hydraulic system, the dispensing system 2 has on the top side a filling and bleeding opening 15 and the brake mechanism 4 also has a filling and bleeding opening 16 (FIG. 3).

A bleeding and filling tool 23 with a piston/cylinder arrangement is associated with the brake system 1 and the filling and bleeding opening 15 of the dispensing system 2 and preferably also the filling and bleeding opening 16 of the brake mechanism 4 are constructed for detachable and tight coupling with this bleeding and filling tool 23. The detachable coupling between the bleeding and filling tool 23 and the filling and bleeding opening 15, 16 of the dispensing system or the brake mechanism 4 is here formed through a sealing insertion process. For this purpose, the bleeding and filling tool 23 has a connecting sleeve 22 or a similar connecting element, which is inserted into the filling and bleeding opening(s).

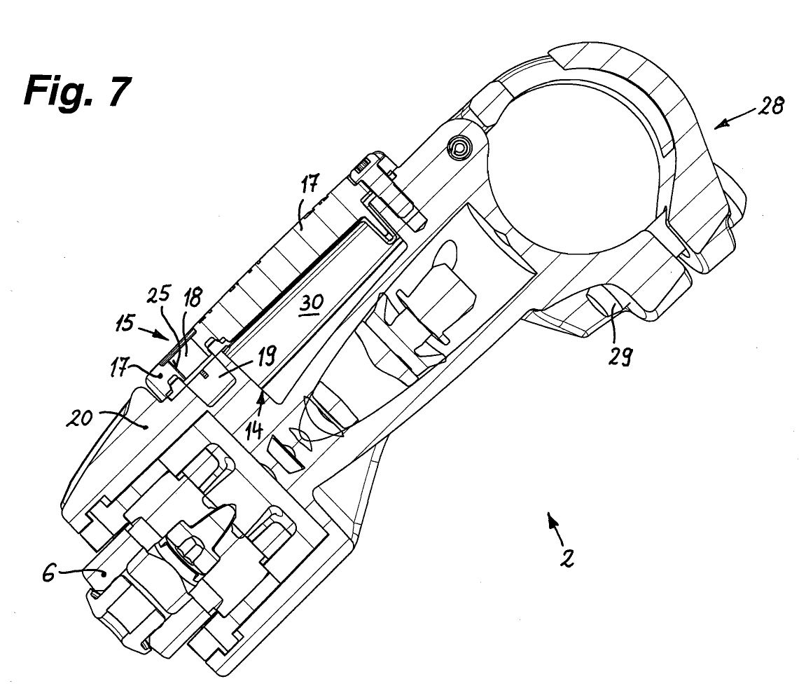

Especially in FIG. 7 it is easy to see that the filling and bleeding opening 15 in the cover 17 has an insertion section 18, which attaches to a connection chamber 19 in the dispenser housing 20 preferably flush in the axial projection. The connection chamber 19 has a pot or cup shape and at its top edge it has slot-shaped overflow openings 21 that are open at the edge to the equalizing reservoir 14. In this way there is a flow connection between this connection chamber 19 and the equalizing reservoir 14.

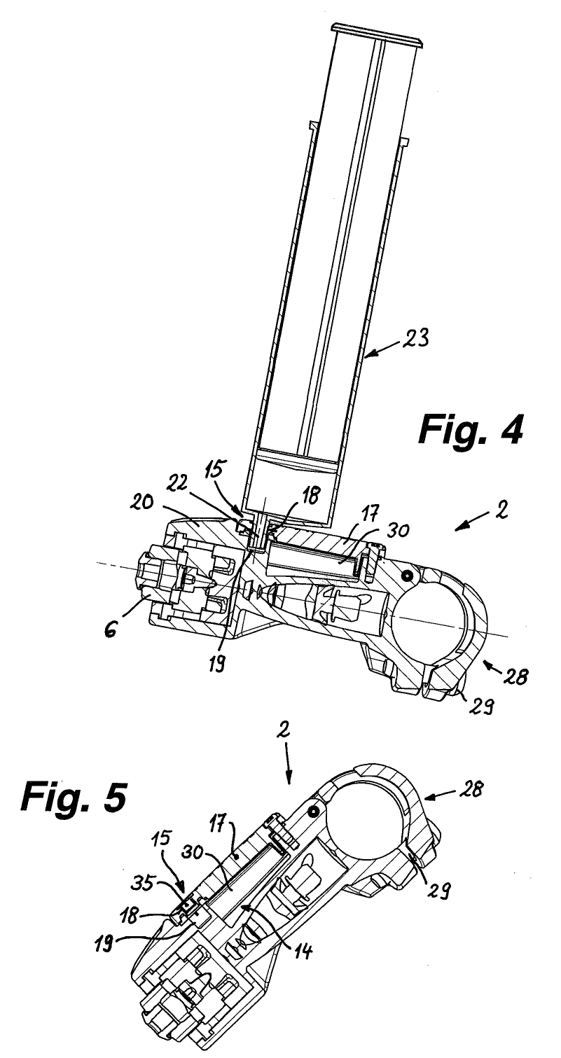

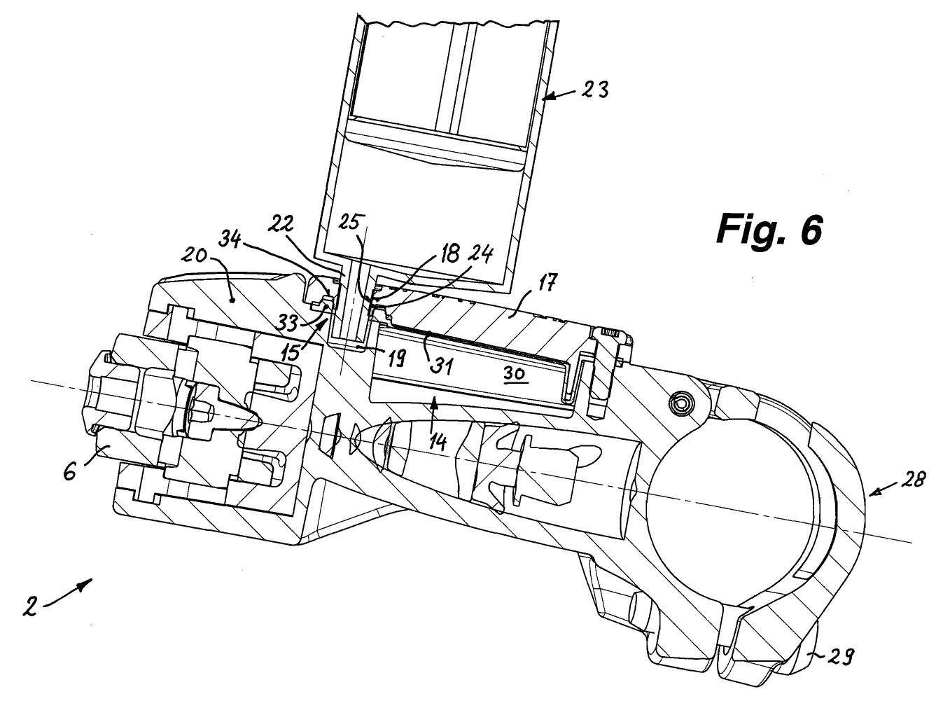

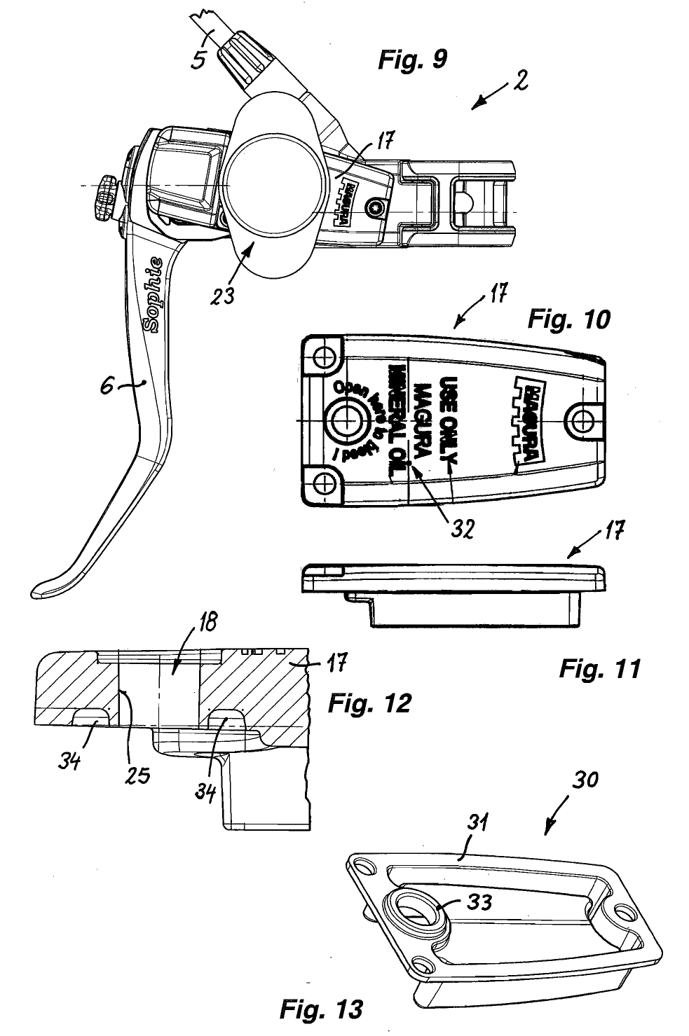

The insertion section 18 of the filling and bleeding opening 15 is constructed for the tight holding of the connecting sleeve 22 of the bleeding and filling tool 23 and for this purpose has a receiving cone 25. The receiving cone 25 is constructed for receiving the insertion of a connecting sleeve 22 formed as a Luer cone 24 in the bleeding and filling tool 23 (FIG. 6). In this way, there is the possibility to use a standard syringe, as can be seen in FIGS. 4, 6, and 9, as the bleeding and filling tool 23.

The insertion connection with the receiving cone 25 and the connecting sleeve 22 is dimensioned so that the connecting sleeve 22 projects in some regions into the connection chamber 19 in the inserted position, wherein it still has some distance to the base of the connection chamber 19 with its inner end, as can be clearly well in FIG. 6. In this inserted position, the connecting sleeve 22 of the bleeding and filling tool 23 are held securely in the cover 17, so that the tool is reliably prevented from unintentionally slipping out even during handling during a bleeding or filling process.

The connection chamber 19 has open dimensions, which are greater than that of the projecting part of the connecting sleeve 22, so that there is still space for an overflow of hydraulic fluid through the overflow openings 21.

In the shown embodiment, the filling and bleeding opening 15 of the dispensing system 2 is provided on the top side of this system and passes through a cover 17 closing the equalizing reservoir 14 on the top side (FIGS. 4 to 7). This cover is connected by screws to the dispenser housing 20.

The construction of the filling and bleeding opening 15 forming a feed channel for the equalizing reservoir 14 divided, on one hand, into two preferably axially flush sections—insertion section 18, connection chamber 19—and arranged, on the other hand, in two parts that can be produced separately—cover 17, dispenser housing 17—has considerable advantages in terms of production, because it involves individual boreholes, which can be easily produced by molding pins. The feed channel of the filling and bleeding opening 15 involves a stepped borehole in the functional position with an inner step that is greater in diameter, which would signify increased complication in terms of molding for a one-piece construction due to the undercut.

The insertion section 18 in the cover 17 and the connection chamber 19 in the dispenser housing 20 are aligned with reference to their longitudinal axes so that they each run in the ejection direction of the cover or the dispenser housing and thus allow trouble-free removal from the molds. Through the construction of the preferably slot-shaped overflow openings 21, which are open at the edge and which are similarly oriented in the ejection direction, these can also be produced easily.

In the embodiment, the filling and bleeding opening 15 is arranged at the side next to the equalizing reservoir 14 and located on the highest side next to the equalizing reservoir 14 in the filling and bleeding position from FIG. 6. The cover 17 is here constructed so that it also overlaps this area of the dispenser housing 20 located at the side next to the equalizing reservoir 14.

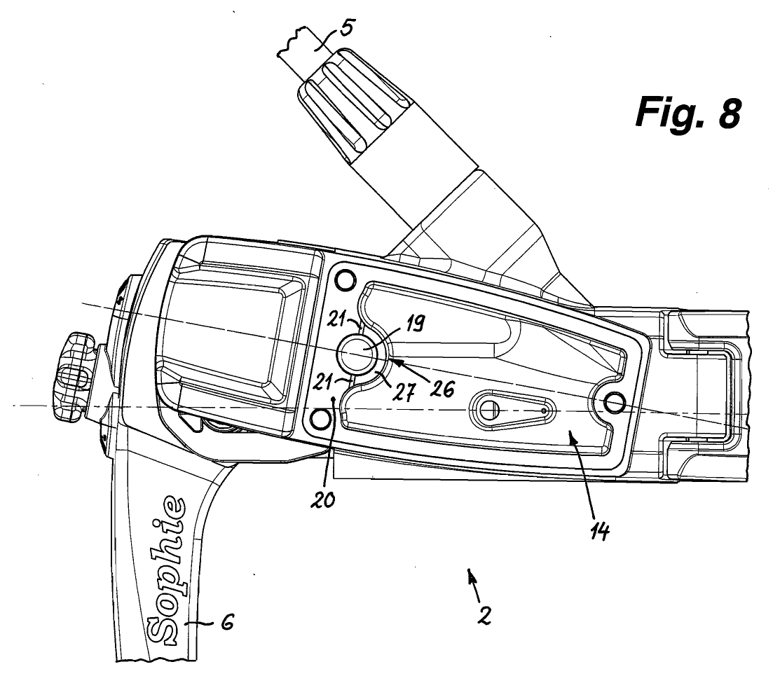

In FIG. 8, for an equalizing reservoir 14 that is open at the top, that is, without the cover 17 and removed bellows 30 (FIG. 13), it is easy to see that the connection chamber 19 of the filling and bleeding opening 15 is arranged in a bulge 26 of the dispenser housing 20 projecting laterally into the equalizing reservoir 14. The connection chamber 19 is here surrounded by a boundary wall 27, in which are located two slot-shaped overflow openings 21 that are open upwards at the edge. The two overflow openings 21 are laterally offset to the front-most region of the bulge 26 facing the equalizing reservoir 14. In this way it is achieved that air bubbles, possibly still located in the connection chamber 19 after a filling and bleeding process, cannot be led into the equalizing reservoir 14 via the overflow openings 21 in the diagonal operating position of the dispensing system 2 shown in FIG. 7, but instead remain trapped in the somewhat higher lying part of the connection chamber 19. The fact that the overflow openings 21 are constructed as narrow edge slots also contributes to this, wherein the slot width is dimensioned for holding back air bubbles contained in the hydraulic fluid.

An elastic bellows 30, which, as can be seen in FIG. 13, has a trough shape and a surrounding seal 31 formed as a flange, is inserted into the equalizing reservoir 14. This bellows 31 is inserted into the equalizing reservoir 14 and fills up the reservoir in some sections. The seal 31 contacts the edge region of the equalizing reservoir and thus the dispenser housing 20. Through the attached cover 17, the bellows 30 and also the equalizing reservoir 14 are then closed and sealed from the outside. The hollow space of the bellows 30 is connected to the outer atmosphere via a bellows ventilation opening 32 (FIGS. 1 and 10) through the cover 17.

The surrounding seal 31, which is arranged between the equalizing reservoir 14 and the cover 17 sealing it at the top side and which is formed by the side flange of the bellows 30, also extends into the side region next to the equalizing reservoir 14 and here between the insertion section 18 and the connection chamber 19 of the filling and bleeding opening 15.

In this region, the seal 31 is provided with an annular bead 33, as can be easily seen in FIGS. 6 and 13. In an approximately complementary way to this annular bead 33, the cover region surrounding the insertion section 18 has an annular groove 34 to receive this annular bead 33 in a sealing way (FIG. 12). The annular bead 33 contacts with its bottom side the top edge of the connection chamber 19 or its boundary wall 27 (FIG. 6). The overflow openings 21 located in the boundary wall 27 and open at the edge are bridged by the annular bead 33, wherein the increased inherent stability of the annular bead 33 in comparison with the flat construction of the seal in the adjacent region provides for a good seal also in the bridging region.

When the bleeding and filling tool 23 are removed, the filling and bleeding opening 15 can be closed with an elastic sealing plug 35 preferably provided with a cone (FIG. 5).

The filling and bleeding opening 15 preferably has an insertion section 18 with a holding cone 25, in which the sealing plug 35 provided with a matching external cone can be inserted. The sealing is realized here by the conical connection.

The sealing plug 35 can have an insertion hole that is accessible from the outside as a tool contact point for a turning tool. This contact point is preferably constructed as a hexagon socket for a hex wrench as a turning tool.

Therefore, after inserting the turning tool, the sealing plug 35 can be turned, for example, with this tool and in this way removed, supported by the conical connection. Through the internal tool contact point, the inserted sealing plug can lie flush with or even somewhat deeper than the outside of the cover or the opening of the insertion section 18 in the cover 17, so that unintentional loosening or removal of the sealing plug is practically ruled out.

The sealing plug can be made from a hard plastic material, for example, from the same material as the cover 17. Other materials can also be used, wherein all that must be reliably ensured is that the moment for turning the sealing plug 35 can be transferred from the turning tool.

It should be mentioned that instead of a sealing plug 35, a sealing screw can also be provided, which can be screwed into a threaded bore hole of the filling and bleeding opening 15, wherein the seal is reached through the end face.

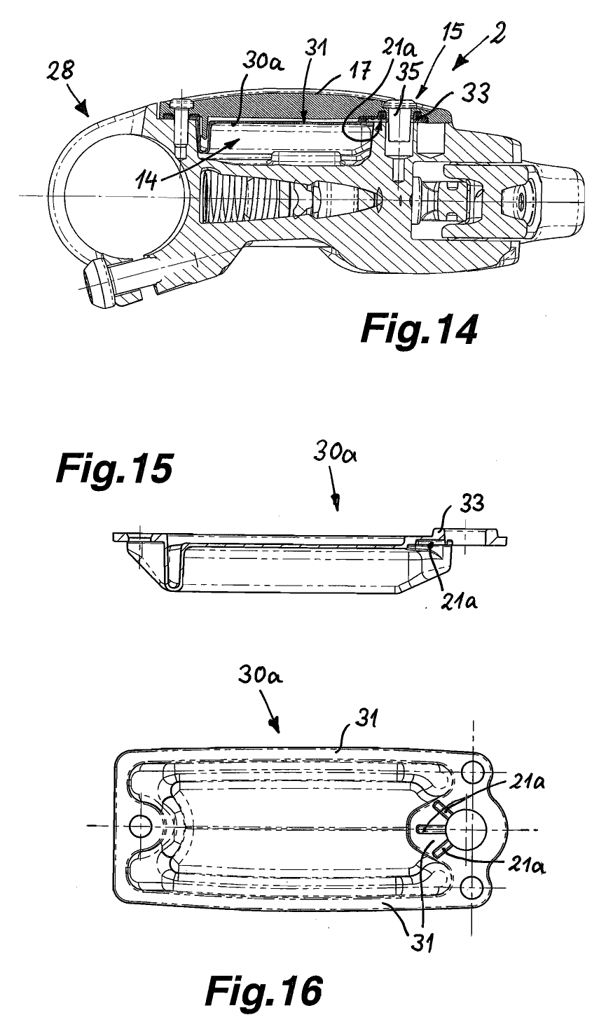

In the dispensing system 2 shown in section in FIG. 14, overflow openings 21a from the connection chamber to the equalizing reservoir are arranged, instead of in the boundary wall 27 of the connection chamber 19, as described above, in a counterpart, which contacts the boundary wall and which, in the embodiment, is the seal 31 between the cover and the equalizing reservoir as part of the bellows 30a. The seal 31 is here formed by the surrounding side flange of the elastic bellows 30a (FIGS. 15 and 16).

The seal or side flange extends past the region of the connection chamber 19 and its boundary wall 27, wherein, in the embodiment, the three, channel-shaped overflow openings 21a (FIG. 16) are arranged in the bellows side flange and thus the seal 31 and overlap the boundary wall 27, that is, project with their ends, on one side, into the equalizing reservoir 14 and, on the other side, into the connection chamber 19. Through these overflow openings or overflow channels, a flow connection is provided between the connection chamber 19 and the equalizing reservoir 14.

The overflow openings 21a are constructed as grooves, which are open at the edge and which face the boundary wall 27 with their openings.

The seal 31 is thicker in the contact region with the boundary wall 27 of the connection chamber 19 (FIG. 15), so that, on one hand, an increased inherent stability is present in this region and, on the other hand, spatial relationships are provided for overflow openings 21a that are sufficiently dimensioned in cross section.

It should be mentioned that the one or more overflow openings 21 from the connection chamber 19 to the equalizing reservoir 14 can also be provided directly in the cover 17, if this cover is made from a suitable material for realizing a seal for the connection chamber 19. Here, the overflow openings are also arranged at the corresponding position like for the seal 31. Furthermore, the one or more overflow openings could also be constructed as a borehole in the side wall of the connection chamber 19. For shaping processes, like, for example, injection molding, however, overflow openings that are open at the edge can be realized easily.

The dispensing system 2 can be connected to the handlebars of a two-wheel vehicle by means of a holder 28. The holder 28 is constructed like a clamp and can be tightened or loosened with the help of a clamping screw 29. In this way, the dispensing system can be easily set into the matching position, on one hand, for the operation (FIGS. 5 and 7) and accordingly for good operability and, on the other hand, for the filling and bleeding process (FIGS. 4 and 6) accordingly. It should be mentioned that the dispensing system 2 can be easily moved from a position with a nearly vertical bleeding and filling tool 23 as shown in FIGS. 4 and 6 to an approximately horizontal position of the bleeding and filling tool 23 for the filling and especially the bleeding process.

For filling the hydraulic system, the syringe forming the bleeding and filling tool 23 can be placed on the top side of the dispensing system 2 according to FIGS. 4, 6, and 9 and in this way inserted tightly into the holding cone 25 of the filling and bleeding opening 15 with its connecting sleeve 22. The provided conical connection produces a secure and tight connection with just slight pressure. For the brake mechanism 4, a container with hydraulic fluid can be connected to the filling and bleeding opening 16, wherein this container can also be a syringe filled with hydraulic fluid.

Preferably, the filling and bleeding opening 16 of the brake mechanism 4 is also provided with a Luer attachment cone, so that here standard syringes can also be used as the bleeding and filling tool 23.

With the syringe attached at the top in the dispensing system 2, the hydraulic fluid is suctioned and then flows from below into the hydraulic system. The lower syringe filled with hydraulic fluid can act in a supporting way, so that the filling process can be completed quickly.

What is claimed is:

1. Brake system with hydraulic brake equipment for two-wheel vehicles, having a filling device for the brake equipment, wherein the brake system comprises a dispensing system filled with hydraulic fluid and a brake mechanism hydraulically connected to this dispensing system, the dispensing system has an equalizing reservoir and a filling and bleeding opening, and a bleeding and filling tool, having a piston/cylinder arrangement, is associated with the brake system and at least the filling and bleeding opening of the dispensing system is detachably coupleable to the bleeding and filling tool.

2. The brake system according to claim 1, wherein the detachable coupling between the bleeding and filling tool and at least the filling and bleeding opening of the dispensing system is formed by sealing insertion.

3. The brake system according to claim 1, wherein the filling and bleeding opening of the dispensing system is arranged at a top portion of the dispensing system, in a cover of the equalizing reservoir.

4. The brake system according to claim 1, wherein the brake mechanism has a filling and bleeding opening, detachably coupleable with the bleeding and filling tool, by sealing insertion.

5. The brake system according to claim 1, wherein the bleeding and filling tool further comprises a connecting sleeve or a similar connecting element for sealing insertion into the filling and bleeding opening.

6. The brake system according to claim 5, wherein the connecting sleeve of the bleeding and filling tool comprises a Luer cone or a Luer lock and the filling and bleeding opening of the dispensing system or the filling and bleeding opening of the brake mechanism are configured to fit the connecting sleeve.

7. The brake system according to claim 1, wherein the bleeding and filling tool is a standard syringe.

8. The brake system according to claim 1, wherein the bleeding and filling tool is integrated into the dispensing system.

9. The brake system according to claim 5, wherein at least the filling and bleeding opening of the dispensing system has an insertion section for tightly sealing the connecting sleeve of the bleeding and filling tool in an equalizing reservoir cover, and a cup-shaped connection chamber in the dispenser housing, into which a part of the connecting sleeve projects and which has at least one connection to the equalizing reservoir, connects to an insertion section in an insertion direction.

10. The brake system according to claim 9, wherein the connection chamber comprises a side boundary wall to the equalizing reservoir and at least one overflow opening that is open at an edge is provided in the boundary wall as a connection to the equalizing reservoir.

11. The brake system according to claim 10, wherein the connection chamber has open inner dimensions, which are greater than the projecting part of the connecting sleeve, and the overflow opening that is open at the edge in the boundary wall of the connection chamber is arranged in a region at a distance from a highest position of the side boundary wall in an operating position of the dispensing system.

12. The brake system according to claim 10, wherein the as least one overflow opening comprises two overflow openings, which are preferably arranged opposite each other and which are open at the edge, are provided in the boundary wall of the connection chamber.

13. The brake system according to claim 10, wherein the at least one overflow opening arranged in the boundary wall of the connection chamber is constructed as a narrow edge slot and the slot width is dimensioned for holding back air bubbles contained in the hydraulic fluid.

14. The brake system according to claim 1, wherein an elastic sealing plug is provided, having a cone or a sealing screw for closing the filling and bleeding opening.

15. The brake system according to claim 14, wherein the filling and bleeding opening has an insertion section with a holding cone and the sealing plug has a matching outer cone and an insertion cavity externally accessible as a tool contact point for a turning tool.

16. The brake system according to claim 15, wherein the insertion cavity of the sealing plug is arranged as a hexagon socket for a hex wrench as the turning tool.

17. The brake system according to claim 16, wherein the sealing plug inserted into the filling and bleeding opening forms an approximately flush seal with the opening of the insertion section or the cover.

18. The brake system according to claim 15, wherein the sealing plug is made from a hard plastic material.

19. The brake system according to claim 15, wherein the outer cone of the sealing plug corresponds to a Luer cone.

20. The brake system according to claim 1, wherein the dispensing system is connected by a holder to a portion of the two-wheel vehicle, in particular the handlebars, which is arranged for shifting the dispensing system at least between a filling and bleeding position and an operating position.

21. The brake system according to claim 10, wherein the filling and bleeding opening has an insertion section arranged in a cover of the equalizing reservoir for the tight holding of a bleeding and filling tool, which connects in an insertion direction to a connection chamber in the dispenser housing, which has a side boundary wall to the equalizing reservoir, and that at least one overflow opening to the equalizing reservoir is provided in the boundary wall or in a counterpart contacting the boundary wall.

22. The brake system according to claim 21, wherein the at least one overflow openings from the connection chamber to the equalizing reservoir is provided in the cover.

23. The brake system according to claim 21, wherein the at least one overflow opening from the connection chamber to the equalizing reservoir is provided in a seal between the cover and the equalizing reservoir.

24. The brake system according to claim 23, wherein the at least one overflow opening provided in the seal is constructed as grooves, which are open at an edge of a region overlapping the boundary wall and which face the boundary wall.

25. The brake system according to claim 24, wherein the seal is thicker at least in the contact region on the boundary wall of the connection chamber and has at least one groove-shaped overflow opening that is open at the edge.

26. The brake system according to claim 23, wherein the seal with the one or more overflow openings is the surrounding side flange of an elastic bellows.
